(19) United States
(12) Patent Application Publication
(10) Pub. No.: US 2008/0025237 A1
(43) Pub. Date: Jan. 31, 2008

(54) MULTIPLEX TRANSMISSION APPARATUS, MULTIPLEX TRANSMISSION SYSTEM, AND MULTIPLEX TRANSMISSION METHOD

(75) Inventor: Keiichi YAMADA, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, Minato-ku, Tokyo (JP)

(21) Appl. No.: 11/828,506

(22) Filed: Jul. 26, 2007

(30) Foreign Application Priority Data
Jul. 26, 2006 (JP) 2006202861

(51) Int. Cl. H04L 5/22

(52) U.S. Cl. 370/301

(57) ABSTRACT

A multiplex transmission apparatus for multiplexing and transmitting a synchronous signal synchronized with a clock signal and an asynchronous signal asynchronized with a clock signal, the apparatus includes a clock extracting unit that extracts a first clock from the synchronous signal, and a multiplexing unit that multiplexes the synchronous signal and the asynchronous signal into a multiplexed signal to be transmitted in accordance with the first clock.

### BACKGROUND OF THE INVENTION

1. Field of the Invention

The present invention relates to a multiplex transmission apparatus, a multiplex transmission system, and a multiplex transmission method. More particularly, the present invention relates to such a transmission apparatus, system and method for multiplex-transmitting a synchronous signal that is synchronous with a clock signal and an asynchronous signal that is asynchronous with the clock signal.

2. Description of the Related Art

Synchronous Digital Hierarchy (SDH) is a known high-speed optical fiber digital communication system. The SDH is a digital multiplexing standard assuming that synchronization is performed over the entire network, and has been standardized by the International Telecommunication Union since 1988. Synchronous Transport Module Level-1 (STM-1) is a basic unit for multiplexing in the SDH. According to STM-1, one frame is formed by a signal of 9 rows×270 columns (bytes). A frame period is defined as 125 μs (microsecond) and therefore a transmission speed as a reference is 155.52 Mbps.

Clock management is important for synchronous multiplex transmission. Reference document 1 (Japanese Patent Application Laid-Open Publication No. Hei 5-227177) describes a clock supply system in a transmission system corresponding to SDH. According to this transmission system, ADMs (Add Drop Multiplexers) are provided in an annular shape. Then, when a clock is not extracted from a signal of one transmission line, a clock is extracted from a signal of a different transmission line (in an opposite direction). Network synchronization of the transmission system is maintained by use of this clock.

Thus, the reference document 1 shows one example of a clock extraction method in an SDH synchronous multiplex transmission system.

In addition, with the diversity of networks in recent years, there is needed a technique in which signals of various bit rates and types can be transmitted. For example, a technique has been proposed in which a signal with speed that is synchronous with the transmission line (hereinafter referred to as “synchronous signal”) and a signal with speed that is asynchronous with the transmission line (hereinafter referred to as “asynchronous signal”) can be transmitted.

In a multiplex transmission system that multiplex-transmits the aforementioned synchronous signal and asynchronous signal, a usable clock can be selected from clocks including an internal clock, an external clock, and a clock extracted from each signal. Since clocks of various types are present, such a system has a problem in that management of the clocks to be used tends to be complicated.

To deal with this problem, reference document 2 (Japanese Examined Patent Publication No. Hei 8-13021) shows a clock management method in a multiplex transmission system that multiplex-transmits a synchronous signal and an asynchronous signal. A multiplexer of the multiplex transmission system includes a stuff circuit unit, a multiplexing unit and a clock generating unit. The clock generating unit generates a clock according to the transmission line. The stuff circuit unit causes the asynchronous signal to be synchronized with the asynchronous clock extracted from the asynchronous signal, then writes the synchronized result in a buffer memory, and thus reads the result according to a clock generated from the clock generating unit. In other words, the stuff circuit unit performs stuff processing to the asynchronous signal and thereby converts the asynchronous signal to a stuff synchronized signal. The multiplexing unit time-division multiplexes the stuff synchronized signal and the synchronous signal, and thus transmits the multiplexed signal to the transmission line.

However, in the reference document 2, the asynchronous signal is synchronized with the asynchronous clock extracted from the asynchronous signal whereby stuff processing is performed. Since the asynchronous clock is not synchronized, delicate speed regulation is needed when stuff processing is performed using the asynchronous clock as in the reference document 2. For this reason, the reference document 2 has a problem in which processing becomes complicated. Moreover, in the reference document 2, the asynchronous signal is initially written in a buffer memory and thereafter is time-division multiplexed with the synchronous signal. Accordingly, in the reference document 2, a buffer memory is needed, and this causes a problem in which the configuration becomes complicated.

### SUMMARY OF THE INVENTION

In view of the foregoing and other exemplary problems, drawbacks, and disadvantages of the related art methods and structures, the present invention seeks to provide a multiplex transmission apparatus, a multiplex transmission system, and a multiplex transmission method thereof for multiplex-transmitting a synchronous signal and an asynchronous signal, which make it possible to more easily manage a clock to be used, preferably with a simple configuration and method.

A multiplex transmission apparatus for multiplexing and transmitting a synchronous signal synchronized with a clock signal and an asynchronous signal asynchronized with a clock signal according to the present invention, the apparatus includes a clock extracting unit that extracts a first clock from the synchronous signal, and a multiplexing unit that multiplexes the synchronous signal and the asynchronous signal into a multiplexed signal to be transmitted in accordance with the first clock.

A multiplex transmission system for multiplexing and transmitting a synchronous signal synchronized with a clock signal and an asynchronous signal asynchronized with a clock signal according to the present invention, the system includes the above-mentioned multiplex transmission apparatus, a transmission line that transmits the multiplexed signal from the multiplex transmission apparatus, and a multiplex reception apparatus that receives the multiplexed signal through the transmission line and demultiplexes the multiplexed signal into the synchronous signal and the asynchronous signal.

A multiplex transmission method of multiplexing and transmitting a synchronous signal synchronized with a clock signal and an asynchronous signal asynchronized with a clock signal according to the present invention, the method includes extracting a first clock from the synchronous signal, multiplexing the synchronous signal and the asynchronous signal into a multiplexed signal in accordance with the first clock, and transmitting the multiplexed signal.

Accordingly, with the simple configuration and method as described above, the multiplex transmission apparatus, the multiplex transmission system, and the multiplex transmission method of the present invention produces an effect in which a clock to be used can be easily managed.

### BRIEF DESCRIPTION OF THE DRAWINGS

Various aspects, features and advantages of the present invention will become more apparent from the following detailed description of preferred embodiments when taken in conjunction with the accompanying drawings wherein:

FIG. 1 is a block diagram illustrating a schematic configuration of a multiplex transmission system according to a first embodiment of the present invention;

FIG. 2A is a block diagram illustrating a detailed configuration of a multiplex transmission system according to the first embodiment of the present invention;

FIG. 2B is a block diagram illustrating a detailed configuration of a multiplex transmission apparatus according to the first embodiment of the present invention;

FIG. 3 is a diagram conceptually showing a configuration of an SDH frame (STM-N frame); and

FIG. 4 is a block diagram illustrating a schematic configuration of a multiplex transmission system according to a second embodiment of the present invention.

### DETAILED DESCRIPTION OF PREFERRED EMBODIMENTS

Preferred embodiments for carrying out the present invention will be described in detail below with reference to the drawings. The preferred embodiments described below show only illustrative examples in understanding the present invention, and the claims of the invention are not limited to these preferred embodiments.

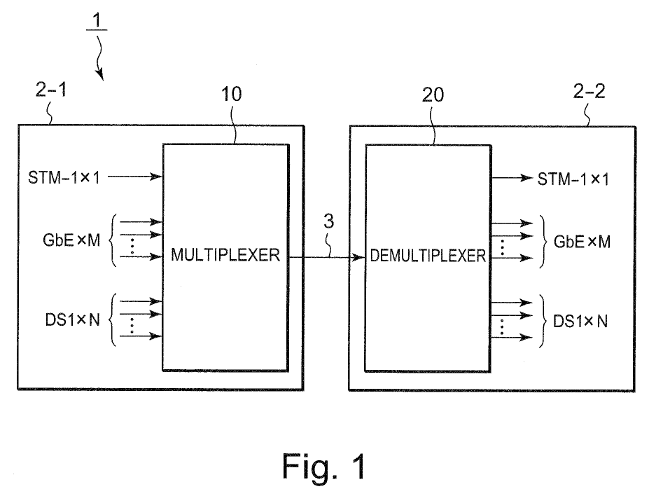

In FIG. 1, a multiplex transmission system 1 complies with SDH (Synchronous Digital Hierarchy). A frame period is defined as 125 μs (microsecond) and therefore a transmission speed as a reference is 155.52 Mbps. In FIG. 1, the multiplex transmission system 1 includes a transmitter 2-1 as a multiplex transmission apparatus on a transmitting side and a receiver 2-2 as a multiplex transmission apparatus on a receiving side and a transmission line 3. The transmitter 2-1 and the receiver 2-2 are connected to each other through the transmission line 3. The transmission line 3 in this embodiment is an optical fiber.

The transmitter 2-1 includes a multiplexer 10. The multiplexer 10 multiplexes an input signal to generate a multiplexed signal, and transmits the generated multiplexed signal to the transmission line 3. The transmission line 3 transmits the multiplexed signal sent from the transmitter 2-1 to the receiver 2-2. The receiver 2-2 receives the multiplexed signal transmitted through the transmission line 3. The receiver 2-2 includes a demultiplexer 20. The demultiplexer 20 demultiplexes the received multiplexed signal to reproduce each signal. Additionally, in the example of the first embodiment, data transmission between the transmitter 2-1 and the receiver 2-2 is completely transparent transmission. That is, the signal inputted to the transmitter 2-1 is outputted from the receiver 2-2 without any change. It should be noted, however, that the present invention is not limited to transparent transmission.

According to the first embodiment, multiplex transmission of a “synchronous signal,” which is synchronized with a clock signal, and an “asynchronous signal,” which is not synchronous therewith, is performed. For example, in FIG. 1, the synchronous signal is a signal that complies with Synchronous Transport Module Level-1, 155.52 Mbps (STM-1). On the other hand, the asynchronous signal includes, for example, a GbE signal and a DS1 signal. The GbE signal (1.25 Gbps) is a signal that complies with a GbE (Giga-bit Ethernet (registered trademark)) standard. The DS1 signal (1.544 Mbps) is a signal that complies with a Digital Signal Level-1 (DS1) standard. It should be noted that the aforementioned signals have been taken as examples for the purpose of explanation of this embodiment, and the present invention is not limited to these signals.

In the example in FIG. 1, one STM-1 signal, M GbE signals (M is a natural number) and N DS1 signals (N is a natural number) are inputted to the multiplexer 10 of the transmitter 2-1. The multiplexer 10 multiplexes these signals to generate a multiplexed signal, and then transmits the generated multiplexed signal to the transmission line 3. The demultiplexer 20 provided in the receiver 2-2 receives the multiplexed signal transmitted through the transmission line 3. Then, the demultiplexer 20 demultiplexes the multiplexed signal into one STM-1 signal, M GbE signals, and N DS1 signals.

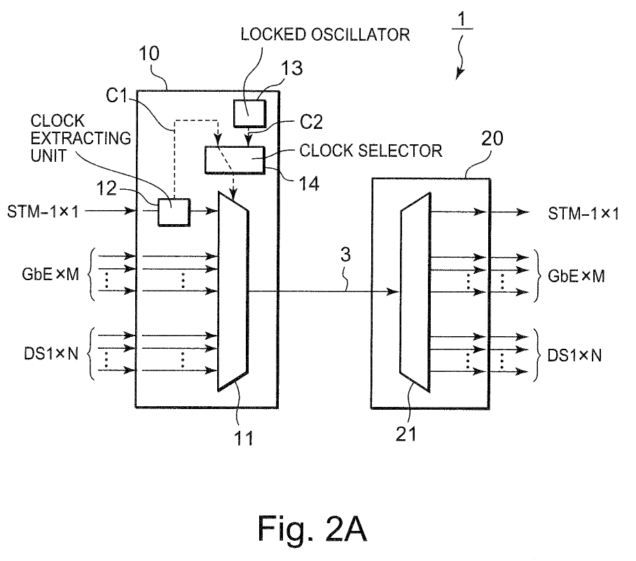

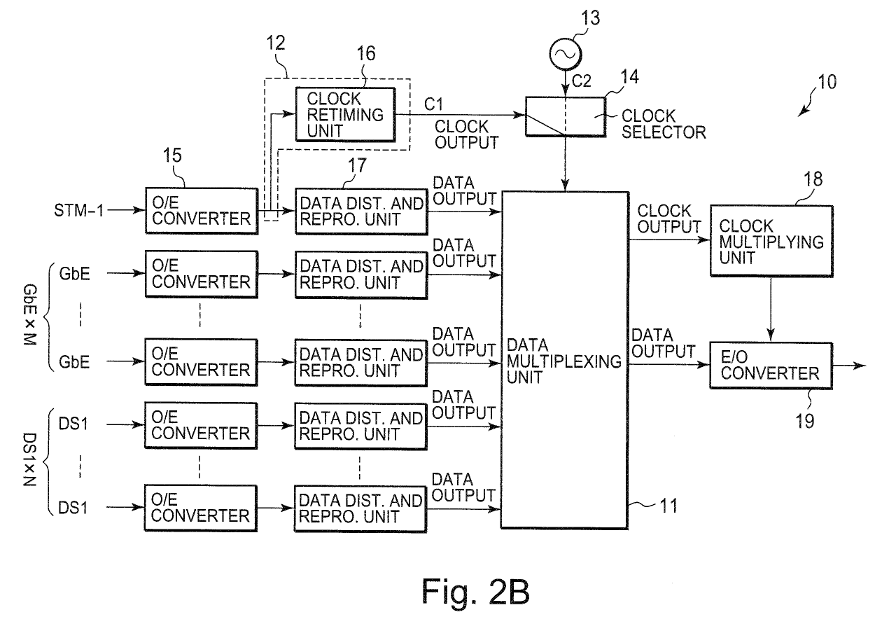

FIG. 2A is a block diagram illustrating a detailed configuration of the multiplex transmission system according to the first embodiment of the present invention. FIG. 2A specifically shows a configuration of each of the multiplexer 10 and the demultiplexer 20. The multiplexer 10 includes a data multiplexing unit 11, a clock extracting unit 12, a locked oscillator 13, and a clock selector 14. On the other hand, the demultiplexer 20 includes a data demultiplexing unit 21.

The clock extracting unit 12 receives the STM-1 signal, which is the synchronous signal, and then extracts a clock C1 from the received STM-1 signal. The clock C1 is extracted from the STM-1 signal that complies with the STM signal and therefore is hereinafter referred to as “STM clock.” The clock extracting unit 12 outputs the extracted STM clock C1 to the clock selector 14. Moreover, the clock extracting unit 12 outputs the STM-1 signal to the data multiplexing unit 11.

The locked oscillator 13 generates a free run clock C2, which is used when the STM clock C1 is not normally extracted. The locked oscillator 13 outputs the free run clock C2 to the clock selector 14.

The clock selector 14 receives the STM clock C1 and the free run clock C2, and then selects either one of these clocks. More specifically, when the STM clock C1 is normally extracted, the clock selector 14 selects the STM clock C1. On the other hand, when the STM clock C1 is not normally extracted such as a case where the input of STM-1 signal is stopped, the clock selector 14 selects the free run clock C2. Then, the clock selector 14 outputs the selected clock (C1 or C2) to the data multiplexing unit 11.

The data multiplexing unit 11 receives the clock (C1 or C2) selected by the clock selector 14, in addition to the aforementioned one STM-1 signal, M GbE signals, and N DS1 signals. Then, the data multiplexing unit 11 time-division multiplexes (TDM) these multiple signals in accordance with the selected clock.

In FIG. 2B, it is illustrated that the multiplexer 10 of FIG. 2A further includes an O/E (Optical-to-Electrical) converter 15, a data distinguishing and reproducing unit 17, a clock multiplying unit 18, and an E/O (Electrical-to-Optical) converter 19. Moreover, in FIG. 2B, it is illustrated that the clock extracting unit 12 includes a clock retiming unit 16.

The O/E converter 15 converts the respective optical signals (STM-1, GbE, DS1) to electrical signals. The clock retiming unit 16 extracts an STM clock C1 from the STM-1 signal partially branched by electrical conversion. The data distinguishing and reproducing unit 17 distinguishes data of the electrically converted signals to reproduce respective data signals. The clock multiplying unit 18 multiplies the clock selected by the clock selector 14 and generates a clock for optically modulating a multiplexed signal outputted from the data multiplexing unit 11. The E/O converter 19 converts an electrically multiplexed signal outputted from the data multiplexing unit 11 to an optically multiplexed signal in accordance with the selected clock multiplied by the clock multiplying unit 18.

The operation of this embodiment will now be described.

As illustrated in FIG. 1, in the multiplex transmission system 1, the multiplexer 10 provided in the transmitter 2-1 receives: one STM-1 signal, which is a synchronous signal; M GbE signals, which are asynchronous signals; and N DS1 signals, which are asynchronous signals. First, the multiplexer 10 converts the respective optical signals (STM-1, GbE, DS1) to electrical signals using the O/E converter 15 as illustrated in FIG. 2B.

As for the clock, the clock retiming unit 16 provided in the clock extracting unit 12 extracts an STM clock C1 from the STM-1 signal partially branched by electrical conversion, and then outputs the extracted STM clock C1 to the clock selector 14. On the other hand, the locked oscillator 13 generates a free run clock C2, and then outputs the generated free run clock C2 to the clock selector 14. When the STM clock C1 is normally inputted, the clock selector 14 selects the STM clock C1, and then outputs the selected STM clock C1 to the data multiplexing unit 11. On the other hand, when the STM clock C1 is not normally inputted, the clock selector 14 selects the free run clock C2, and then outputs the selected free run clock C2 to the data multiplexing unit 11.

As for the signals, the data distinguishing and reproducing unit 17 distinguishes data of the respective signals converted to electrical signals by the O/E converter 15, then reproduces data signals, and thereafter outputs the data signals to the data multiplexing unit 11. The data multiplexing unit 11 maps the respective data signals, which include the STM-signal as a synchronous signal, and GbE signals and DS1 signals as asynchronous signals, on a frame in accordance with the clock selected by the clock selector 14. This mapping method will be described below.

Subsequently, the data multiplexing unit 11 uses the selected clock in mapping these data signals, and concurrently outputs the selected clock to the clock multiplying unit 18. The clock multiplying unit 18 multiplies the selected clock. Then, the E/O converter 19 modulates the electrically multiplexed signal multiplexed by the data multiplexing unit 11 with the multiplied selected clock, and therewith converts the modulated signal to an optically multiplexed signal.

A detailed description of the mapping method performed by the data multiplexing unit 11 will now be made. An SDH frame (STM-N frame), which is synchronized with the clock selected by the clock selector 14, is used as a frame for mapping data signals. N is a natural number, and when N is 1, this corresponds to an STM-1 frame.

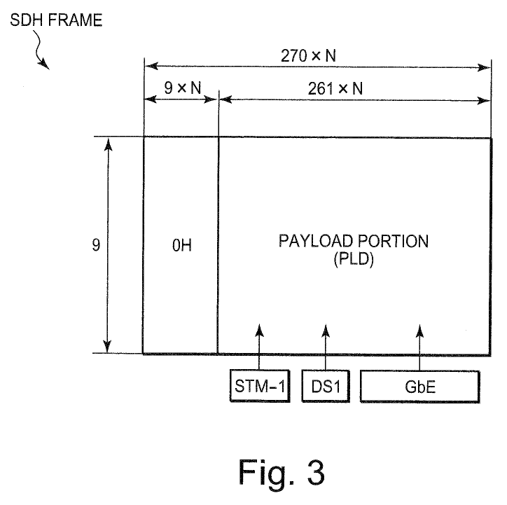

As illustrated in FIG. 3, one SDH frame is formed by a signal of 9 rows×(270×N) columns. A frame period is defined as 125 μs (microsecond). Moreover, the SDH frame includes an overhead portion “OH” (9×N columns) and a payload portion “PLD” (261×N columns) in which information is stored.

An SDH frame to be generated is set to be larger than the frame of any of the multiplexed synchronous signal and asynchronous signals, that is, STM-1, GbE and DS1. As an example, when N is 16, that is, STM-16 frame is used as the SDH frame. In this case, one SDH frame is formed by 9 row×(270×16) columns wherein PLD is formed by 216×16 columns.

The data multiplexing unit 11 maps the multiplexed synchronous signal and asynchronous signal on the PLD of the SDH frame. For example, the GbE signal is mapped on the PLD of the SDH frame by “GFP (General Framing Procedure).” GFP is a technique for mapping a general-purpose frame on the SDH frame and is standardized by ITU-T G. 7041. Moreover, for example, the DS1 signal is mapped on the PLD of the SDH frame by a “stuff multiplexing mode.” The stuff multiplexing mode is standardized by ITU-T G. 707. An SDH frame to be generated is synchronized with the clock selected by the clock selector 14. More specifically, when an STM clock C1 is normally extracted, the SDH frame is synchronized with the STM clock C1, and when the STM clock C1 is not normally extracted, the SDH frame is synchronized with the free run clock C2.

As described above, the data multiplexing unit 11 time-division multiplexes the STM-1 signal as the synchronous signal, and the GbE signals and the DS1 signals as the asynchronous signals, and thus generates a multiplexed signal formed of the SDH frame. Then, the E/O converter 19 converts an electrically multiplexed signal generated therein to an optically multiplexed signal, and thus transmits the converted optically multiplexed signal to the transmission line 3 in accordance with the selected clock multiplexed by the clock multiplexing unit 18.

The optically multiplexed signal transmitted through the transmission line 3 is received by the demultiplexer 20 provided in the receiver 2-2. The data demultiplexing unit 21 provided in the demultiplexer 20 demultiplexes the optically multiplexed signal received therefrom, and thus reproduces one STM signal, M GbE signals, and N DS1 signals. More specifically, in the demultiplexer 20, an O/E converter (not illustrated) converts the optically multiplexed signal to generate an electrically multiplexed signal, and then the data demultiplexing unit 21 demultiplexes the electrical signals mapped on the PLD of the SDH frame to respective electrical signals. Each demultiplexed electrical signal is converted to an optical signal by an E/O converter (not illustrated). Then, one STM signal, M GbE signals and N DS1 signals are reproduced for each electrical signal.

A benefit of this first embodiment is that the clock to be used can be easily managed by the foregoing simple configuration and method. This is because the STM clock C1 extracted from the STM signal as the synchronous signal is normally used. Then, only when the STM clock C1 cannot be extracted, the first embodiment is designed to use the free run clock C2. As a result, the first embodiment facilitates the clock management which tends to be complicated. This in turn makes it possible to decrease the load of the operation and maintenance of the multiplex transmission system.

Moreover, the first embodiment is designed to use the STM clock C1 to be extracted from the STM signal as the synchronous signal, and therefore eliminates the needs for delicate speed regulation, in contrast to an asynchronous clock. As a result, the first embodiment has an effect in which processing is simplified.

Still further, in the first embodiment, there is no need to time-division multiplex the signals for being multiplexed after being initially stored in the buffer memory. This is because the SDH frame, which is larger than the frame of any of the multiplexed signals, is used in mapping the multiplexed signal. As a result, the first embodiment has an effect in which there is no need to provide a buffer memory, and this simplifies the configuration and the method.

The present invention can be also applied to a Wavelength Division Multiplex (WDM) transmission system. According to the WDM transmission system, a plurality of optical signals, each having a respectively different wavelength, are multiplexed, and then the multiplexed signals are transmitted through an optical fiber.

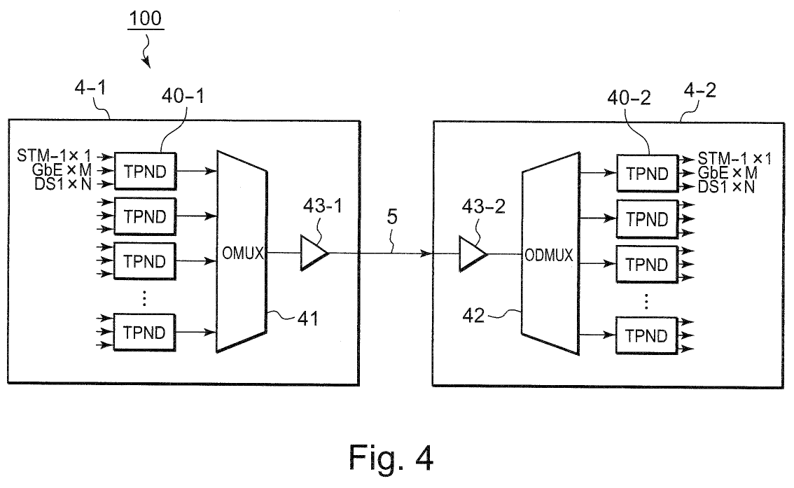

A second embodiment of the present invention will now be described. In FIG. 4, a WDM multiplex transmission system 100 includes: a transmitter 4-1 as a multiplex transmission apparatus on a transmitting side; a receiver 4-2 as a multiplex transmission apparatus on a receiving side; and a transmission line 5. The transmitter 4-1 and the receiver 4-2 are connected to each other through the transmission line 5. The transmission line 5 in this embodiment is an optical fiber.

The transmitter 4-1 converts inputted data to signals each having a predetermined wavelength, and then wavelength-division multiplexes a plurality of signals obtained by wavelength conversion. The transmitter 4-1 thereby generates a wavelength-division multiplexed signal. Then, the transmitter 4-1 transmits the generated wavelength-division multiplexed signal to the receiver 4-2 through the transmission line 5. The receiver 4-2 receives the wavelength-division multiplexed signal through the transmission line 5 and demultiplexes the wavelength-division multiplexed signal received therefrom into a plurality of signals. Furthermore, the receiver 4-2 performs wavelength conversion of these multiple signals to obtain original data.

As illustrated in FIG. 4, the transmitter 4-1 includes a plurality of transponders (TPND) 40-1 and an optical multiplexer (OMUX) 41. On the other hand, the receiver 4-2 includes a plurality of transponders (TPND) 40-2 and an optical demultiplexer (ODMUX) 42. Moreover, the transmitter 4-1 may include an optical amplifying unit 43-1, and the receiver 4-2 may include an optical amplifying unit 43-2. According to the second embodiment, the transponders 40-1 and 40-2 perform the functions of the first embodiment, namely, the functions of the multiplexer 10 and the demultiplexer 20 illustrated in FIGS. 2A and 2B, respectively.

The operation of this second embodiment of the present invention will now be described.

As illustrated in FIG. 4, in the WDM multiplex transmission system 100, one transponder 40-1 provided in the transmitter 4-1 receives one STM-1 signal, M GbE signals, and N DS1 signals. The multiplexer 10 provided in the transponder 40-1 multiplexes these inputted signals in the same way as in the first embodiment. Furthermore, the transponder 40-1 converts the signal obtained by multiplexing to a signal with a predetermined wavelength, and then outputs the signal obtained by the wavelength conversion to the optical multiplexer 41. The predetermined wavelength is different for each of the plurality of transponders 40-1.

The optical multiplexer 41 receives the plurality of signals each having a respectively different wavelength from the plurality of transponders 40-1, respectively. Then, the optical multiplexer 41 wavelength-division multiplexes these signals, and thereby generates a wavelength-division multiplexed signal. The generated wavelength-division multiplexed signal (WDM signal) is amplified by the optical amplifying unit 43-1 to be sent to the transmission line 5 as required.

In the receiver 4-2, the wavelength-division multiplexed signal (WDM signal) transmitted through the transmission line 5 is amplified by the optical amplifying unit 43-2 as needed, and then outputted to the optical demultiplexer 42. The optical demultiplexer 42 receives the wavelength-division multiplexed signal (WDM signal), and then wavelength-division demultiplexes the received wavelength-division multiplexed signal. Thereby, it is possible to obtain a plurality of signals each having a respectively different wavelength. Thus, the optical demultiplexer 42 outputs the plurality of signals, each having a respectively different wavelength, to each of the transponders 40-2.

Each transponder 40-2 receives a signal from the optical demultiplexer 42. Then, each transponder 40-2 converts the received signal to a signal with the original wavelength. Furthermore, the demultiplexer 20 provided in each transponder 40-2 demultiplexes the signal obtained by wavelength conversion in the same way as that used in the first embodiment. As a result, it is possible to obtain one STM signal, M GbE signals, and N DS1 signals.

The second embodiment provides the same advantages as the first embodiment. In other words, in the second embodiment, the clock to be used can be managed easily. Accordingly, it is possible to decrease the operation and maintenance load of the multiplex transmission system. Moreover, similar to the first embodiment, the second embodiment extracts the clock from the STM signal as the synchronous signal and therefore simplifies processing. Furthermore, similar to the first embodiment, in the second embodiment, there is no need to provide a buffer memory, and this simplifies the configuration and the method.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

Further, the inventor's intent is to retain all equivalents of the claimed invention even if the claims are amended later during prosecution.

What is claimed is:

1. A multiplex transmission apparatus for multiplexing and transmitting a synchronous signal synchronized with a clock signal and an asynchronous signal asynchronized with a clock signal, the apparatus comprising:
a clock extracting unit that extracts a first clock from the synchronous signal; and
a multiplexing unit that multiplexes the synchronous signal and the asynchronous signal into a multiplexed signal to be transmitted in accordance with the first clock.

2. The multiplex transmission apparatus according to claim 1, wherein the multiplexing unit time-division multiplexes the synchronous signal and the asynchronous signal.

3. The multiplex transmission apparatus according to claim 1, wherein the synchronous signal is synchronized by a Synchronous Digital Hierarchy (SDH) system.

4. The multiplex transmission apparatus according to claim 3, wherein the synchronous signal is a signal that complies with Synchronous Transport Module Level-1.

5. The multiplex transmission apparatus according to claim 3, wherein the multiplexing unit multiplexes the synchronous signal and the asynchronous signal by mapping these signals on a payload portion of an SDH frame.

6. The multiplex transmission apparatus according to claim 5, wherein the asynchronous signal is mapped on the payload portion by General Framing Procedure.

7. The multiplex transmission apparatus according to claim 5, wherein the asynchronous signal is mapped on the payload portion by a stuff multiplexing mode.

8. The multiplex transmission apparatus according to claim 5, wherein the SDH frame is synchronized with the first clock and is larger than the frame of any one of the synchronous signal and asynchronous signal.

9. The multiplex transmission apparatus according to claim 1, further comprising:
a locked oscillator that generates a free run clock; and
a clock selector that selects one of the first clock and the free run lock,
wherein when the clock extracting unit extracts the first clock, the clock selector selects the first clock to output as a clock for multiplexing to the multiplexing unit and when the clock extracting unit does not extract the first clock, the clock selector selects the free run clock to output as a clock for multiplexing to the multiplexing unit.

10. The multiplex transmission apparatus according to claim 1, further comprising:
a clock multiplying unit that multiplies the first clock; and
an electrical-to-optical converter that converts the multiplexed signal to an optically multiplexed signal in accordance with the multiplied first clock.

11. The multiplex transmission apparatus according to claim 10, wherein the multiplied first clock is used for modulation when the multiplexed signal is converted to the optically multiplexed signal.

12. The multiplex transmission apparatus according to claim 1, further comprising:
a plurality of transponders, each of which has a clock extracting unit, a multiplexing unit and a wavelength converting unit that converts the multiplexed signal to a multiplexed signal having a respectively different wavelength, and that outputs the multiplexed signal having a respectively different wavelength; and
an optical multiplexer that wavelength-division multiplexes a plurality of the multiplexed signals having a respectively different wavelength to output a wavelength-division multiplexed signal.

13. A multiplex transmission system for multiplexing and transmitting a synchronous signal synchronized with a clock signal and an asynchronous signal asynchronized with a clock signal, the system comprising:
the multiplex transmission apparatus according to claim 1;
a transmission line that transmits the multiplexed signal from the multiplex transmission apparatus; and
a multiplex reception apparatus that receives the multiplexed signal through the transmission line and demultiplexes the multiplexed signal into the synchronous signal and the asynchronous signal.

14. The multiplex transmission system according to claim 13, wherein the multiplex reception apparatus comprises a demultiplexing unit that demultiplexes the multiplexed signal into the synchronous signal and the asynchronous signal.

15. A multiplex transmission system for multiplexing and transmitting a synchronous signal synchronized with a clock signal and an asynchronous signal asynchronized with a clock signal, the system comprising:
the multiplex transmission apparatus according to claim 12;
a transmission line that transmits the wavelength-division multiplexed signal from the multiplex transmission apparatus; and
a different multiplex transmission apparatus that receives the wavelength-division multiplexed signal through the transmission line to be wavelength-division demultiplexed to the multiplexed signals having a respectively different wavelength, and demultiplexes the respective multiplexed signals into the synchronous signal and the asynchronous signal.

16. The multiplex transmission system according to claim 15, wherein the different multiplex transmission apparatus includes:
a wavelength-division demultiplexing unit that wavelength-division demultiplexes the wavelength-division multiplexed signal into the multiplexed signals having a respectively different wavelength; and
a demultiplexing unit that demultiplexes the respective multiplexed signals into the synchronous signal and the asynchronous signal.

17. A multiplex transmission method of multiplexing and transmitting a synchronous signal synchronized with a clock signal and an asynchronous signal asynchronized with a clock signal, the method comprising:
extracting a first clock from the synchronous signal;
multiplexing the synchronous signal and the asynchronous signal into a multiplexed signal in accordance with the first clock; and
transmitting the multiplexed signal.

18. The multiplex transmission method according to claim 17, wherein the synchronous signal and the asynchronous signal are time-division multiplexed.

19. The multiplex transmission method according to claim 17, wherein the synchronous signal is synchronized by a Synchronous Digital Hierarchy (SDH) system.

20. The multiplex transmission method according to claim 19, wherein the synchronous signal is a signal that complies with Synchronous Transport Module Level-1.

21. The multiplex transmission method according to claim 19, wherein the synchronous signal and the asynchronous signal are multiplexed by mapping these signals on a payload portion of an SDH frame.

22. The multiplex transmission method according to claim 21, wherein the asynchronous signal is mapped on the payload portion by General Framing Procedure.

23. The multiplex transmission method according to claim 21, wherein the asynchronous signal is mapped on the payload portion by a stuff multiplexing mode.

24. The multiplex transmission method according to claim 21, wherein the SDH frame is synchronized with the first clock and is larger than the frame of any one of the synchronous signal and asynchronous signal.

25. The multiplex transmission method according to claim 17, further comprising:
generating a free run clock;
selecting the first clock as a clock of multiplexing when the first clock is extracted; and
selecting the free run clock as a clock of multiplexing when the first clock is not extracted.

26. The multiplex transmission method according to claim 17, further comprising:
multiplying the first clock;
converting the multiplexed signal to an optically multiplexed signal in accordance with the multiplied first clock; and
transmitting the optically multiplexed signal.

27. The multiplex transmission method according to claim 26, wherein the multiplied first clock is used for modulation when the multiplexed signal is converted to the optically multiplexed signal.

28. The multiplex transmission method according to claim 17, further comprising:
receiving the multiplexed signal that has been transmitted; and
demultiplexing the multiplexed signal into the synchronous signal and the asynchronous signal.

29. The multiplex transmission method according to claim 17, further comprising:
generating a plurality of the multiplexed signals;
converting the multiplexed signals to multiplexed signals, each having a respectively different wavelength;
outputting the multiplexed signals, each having a respectively different wavelength;
wavelength-division multiplexing the multiplexed signals, each having a respectively different wavelength, to a wavelength-division multiplexed signal; and
transmitting the wavelength-division multiplexed signal.

30. The multiplex transmission method according to claim 29, further comprising:
receiving the wavelength-division multiplexed signal that has been transmitted;
wavelength-division demultiplexing the wavelength-division multiplexed signal into the multiplexed signals, each having a respectively different wavelength; and
demultiplexing each of the multiplexed signals into the synchronous signal and the asynchronous signal.
